(19) United States
(12) Patent Application Publication
(10) Pub. No.: US 2026/0099368 A1
(43) Pub. Date: Apr. 9, 2026

(54) BUFFER MANAGEMENT IN FLASH MEMORY

(71) Applicant: Silicon Motion, Inc., Hsinchu County (TW)

(72) Inventors: Yi-Cheng Chen, Hsinchu County (TW); I-Ta Chen, New Taipei City (TW); Wen-Shu Chen, Hsinchu County (TW)

(73) Assignee: Silicon Motion, Inc., Hsinchu County (TW)

(21) Appl. No.: 18/907,588

(22) Filed: Oct. 6, 2024

(51) Int. Cl. G06F 9/50; G06F 13/16

(52) U.S. Cl. CPC G06F 9/5016; G06F 9/5022; G06F 13/1621; G06F 13/1663; G06F 13/1673

(57) ABSTRACT

A buffer management control device for use in a flash memory controller includes: a flag table and a flag management engine. The flag table is configured track availability status of a plurality of allocation units within a shared memory of the flash memory controller. The flag management engine is configured to assign one or more allocation units from the plurality of allocation units for buffering read data related to a host read command, and update the flag table according to the one or more assigned allocation units, thereby indicating that the one or more assigned allocation units are occupied.

### BACKGROUND OF THE INVENTION

### 1. Field of the Invention

The present invention relates to flash memory, and more particularly to a hardware-based buffer management control device and related method, memory controller and data storage device thereof.

### 2. Description of the Prior Art

Flash memory has become an integral component in modern computing systems, offering numerous advantages over traditional storage solutions. Its non-volatile nature, high-speed data access, low power consumption, and compact form factor have made it the preferred choice for a wide range of applications, from consumer electronics to enterprise-level storage systems. The performance and efficiency of flash memory systems are heavily influenced by the architecture and algorithms implemented in a flash memory controller. The flash memory controller serves as the intermediary between a host device and flash memory chips, managing complex operations such as data read/write, wear leveling, garbage collection, and error correction. The effectiveness of these operations directly impacts the overall system performance, reliability, and lifespan of the flash memory.

Conventionally, a flash memory controller has relied on firmware-based algorithms executed by a single-core or multi-core CPU to manage allocation and de-allocation of their internal storage space. Such approach requires the flash memory controller to maintain complex data structures and execute time-consuming searches to determine the availability of storage units.

This approach has several drawbacks: 1) computational overhead; the CPU of the flash memory controller had to dedicate significant processing time to storage management tasks, potentially impacting other critical operations; 2) latency; searching for available storage units could introduce delays in read and write operations, especially as the storage capacity increased; 3) scalability challenges; as flash memory capacities grew, the complexity of managing larger address spaces became more substantial, potentially leading to performance bottlenecks.

### SUMMARY OF THE INVENTION

With this in mind, it is one objective of the present invention to provide a hardware-based buffer management control architecture, which leverages dedicated hardware within a flash memory controller to perform buffer management tasks. Specifically, the present invention introduces a flag management mechanism implemented in hardware, working in synergy with firmware executed by the CPU. By utilizing specialized hardware for implementing buffer management and tracking the availability status of storage units, this task can be efficiently offloaded from the CPU, allowing it to focus on other critical operations and thereby improving overall system performance. Moreover, the hardware-based buffer management control architecture maintains a compact representation of storage unit status, typically implemented as a high-speed, low-latency bitmap or bit vector in dedicated memory. This allows for rapid status checks and updates, potentially reducing buffer management latency by an order of magnitude compared to software-based solutions, and significantly decreasing delays in read and write operations. Furthermore, the hardware-based buffer management control architecture is able to quickly identify available storage units and report this information back to the firmware, dramatically reducing the time required for space allocation decisions. Consequently, the CPU can concurrently handle complex tasks such as garbage collection, wear-leveling algorithms and advanced error correction, further enhancing system efficiency and overall throughput.

According to one embodiment, a buffer management control device for use in a flash memory controller is provided. The buffer management control device comprises: a flag table and a flag management engine. The flag table is configured track availability status of a plurality of allocation units within a shared memory of the flash memory controller. The flag management engine is configured to assign one or more allocation units from the plurality of allocation units for buffering read data related to a host read command, and update the flag table according to the one or more assigned allocation units, thereby indicating that the one or more assigned allocation units are occupied.

According to one embodiment, a buffer management control method for use in a flash memory controller is provided. The buffer management control method comprises: utilizing a flag table to track availability status of a plurality of allocation units within a shared memory of the flash memory controller; and utilizing a flag management engine to assign one or more allocation units from the plurality of allocation units for buffering read data related to a host read command and update the flag table according to the one or more assigned allocation units, thereby indicating that the one or more assigned allocation units are occupied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic device and a data storage device according to one embodiment of the present invention.

FIG. 2 illustrates buffer management control architecture according to one embodiment of the present invention.

FIG. 3 illustrates a schematic diagram of a buffer management control device according to one embodiment of the present invention.

FIG. 4 is an illustration of a pointer-based allocation mechanism according to one embodiment of the present invention.

FIG. 5 illustrates a flow chart of a buffer management control method according to one embodiment of the present invention.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

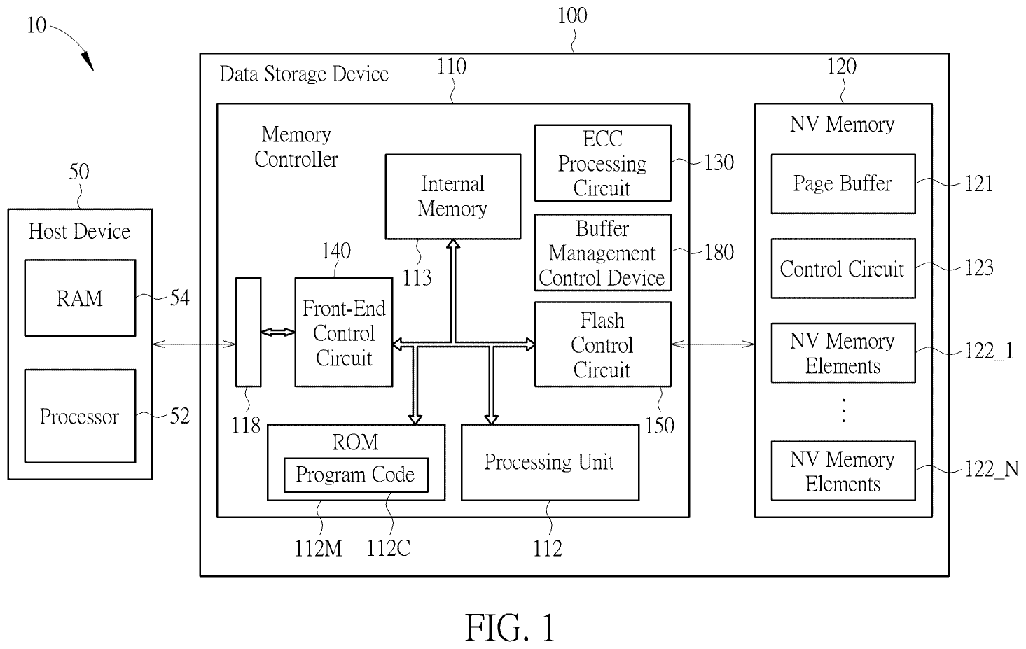

FIG. 1 is a schematic diagram illustrating an electronic device and a data storage device according to one embodiment of the present invention. As illustrated an electronic device 10 comprises a host device 50 and a data storage device 100. The host device 50 may comprise: at least one processor 52 configured to control operations of the host device 50, and a random access memory 54 configured to store data and information required by the processor 52. Examples of the host device 50 may include, but are not limited to: a smartphone, a tablet computer, a wearable device, a personal computer (such as, a desktop computer or a laptop computer), an imaging device (such as, a digital still camera or a video camera), a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a controller (such as, a memory controller 110) and may further comprise a non-volatile (NV) memory 120. The NV memory 120 is configured to store data and information. The NV memory 120 may comprise one or more NV memory elements, such as a plurality of NV memory elements 122_1-122_N. For example, the NV memory 120 may be a flash memory, and the NV memory elements 122_1-122_N may be a plurality of flash memory chips or a plurality of flash memory dies, respectively, but the present invention is not limited thereto. In addition, the NV memory 120 may comprise memory cells having a two-dimensional structure or memory cells having a three-dimensional structure.

As shown in FIG. 1, the memory controller 110 may comprise a processing unit 112, a read-only memory (ROM) 112M, an internal memory 113, a transmission interface circuit 118, an error correction coding (ECC) processing circuit 130, a front-end control circuit 140, a flash control circuit 150 and a buffer management control device 180. At least one portion of these circuits and components may be coupled to one another through a bus. The internal memory 113 can be implemented by one or more RAM devices. For example, the internal memory 113 may comprise a static RAM (SRAM) and/or a dynamic RAM (DRAM). The internal memory 113 could be configured to provide internal storage space for the memory controller 110, for example, temporarily storing information, such as data, addresses, commands, mapping information, and/or variables/parameters. In some embodiments, the memory controller 110 may not include the internal memory 113. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100.

In addition, the ROM 112M in this embodiment is configured to store program code 112C, and the microprocessor 112 is configured to execute the program code 112C, thereby controlling access to the NV memory 120. The program code 112C may include one or more program modules, such as boot loader code. When the data storage device 100 obtains power from the host device 50, the processing unit 112 may execute an initialization process of the data storage device 100 by executing the program code 112C. During the initialization process, the microprocessor 112 may load a set of in-system programming (ISP) codes (not shown in FIG. 1) from the NV memory 120. The microprocessor 112 can execute the ISP codes so that the data storage device 100 can be operable to perform various functions. According to one embodiment of the present invention, the set of ISP codes may include, but are not limited to: one or more program modules associated with memory access (e.g., reading, writing, and erasing), such as, a read operation module, a lookup table module, a wear leveling module, a read refresh module, a read reclaim module, and a garbage collection module, an sudden power-off recovery(SPOR) module, which are provided to perform corresponding reading, lookup table querying, wear leveling, read refreshing, read reclaiming, garbage collection, SPOR and other operations.

The memory controller 110 controls reading, writing, and erasing of the NV memory 120 through a flash control circuit 150. In addition, the memory controller 110 could perform writing of data based on host commands from the host device 50 and writing of valid data which is read from the NV memory 120 by a garbage collection and/or a wear-leveling operation concurrently. The transmission interface circuit 118 may conform to a specific communications specification, such as, Universal Serial Bus (USB) specification, Secure Digital (SD) interface, Ultra High Speed-I (UHS-I) interface, Ultra High Speed-II (UHS-II), CompactFlash (CF) interface, Multimedia card (MMC) interface, embedded Multimedia Card (eMMC) specification, Advanced Technology Attachment (ATA), Serial Advanced Technology Attachment (SATA), Parallel Advanced Technology Attachment (PATA), Peripheral Component Interconnect Express (PCI-E), and Universal Flash Storage (UFS) specification, and may perform communications with the host device 50 according to the specific communications specification.

Typically, the host device 50 may indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120. The NV memory 120 includes one or more page buffers 121 (which may be implemented by SRAM), and one or more control circuits 123. Data that the memory controller 110 intends to program to the NV memory 120 will be written into the page buffer 121 before being programmed to the memory cells. The one or more control circuits 123 will read, program, or erase data based on the memory operation commands sent by the memory controller 110. When the memory controller 110 performs an erase operation on any one of the NV memory elements 122_1-122_N, at least one block in the NV memory element 122_k may be erased. In addition, each block of the NV memory element 122_k can include multiple pages, and access operations (for example, read or write) are performed on one or more pages.

In one embodiment, each of the NV memory elements 122_1-122_N may be a NV memory die or chip. Each of NV memory dies 122_1-122_N is equipped with control circuitry for executing memory operation commands issued by the memory controller 110. Additionally, each of NV memory dies 122_1-122_N may include multiple planes. Each plane might have multiple blocks composed of memory cells, along with associated row and column control circuitry. Memory cells in each plane can be arranged in either a 2D or 3D memory structure. Moreover, through multi-plane operation commands, various memory operations can be parallel or simultaneously performed on different planes. That is, memory operations can be applied parallel or simultaneously on memory blocks of different planes to perform multi-plane reading, writing or erasing operations. In one embodiment, the memory controller 110 can be utilized to combine memory blocks of the NV memory 120 into multiple super blocks. In one embodiment, a composition of a super block can span across NV memory chips 122_1-122_N. Additionally, the super block can be utilized as one or more storage blocks in each of NV memory chips 122_1-122_N.

In one embodiment, a logical-to-physical (L2P) address mapping table having multiple L2P address mapping entries, can be divided into multiple mapping groups. Each mapping group includes a part of entries of the L2P address mapping table and is utilized for performing logical-to-physical address translation. These L2P mapping groups are permanently stored in blocks of NV memory 120 and are loaded into the internal memory 113 when needed. Similarly, a physical-to-logical (P2L) address mapping table having multiple P2L address mapping entries, can be divided into multiple mapping groups. Each mapping group includes a part of entries of the P2L address mapping table and is utilized for performing physical to logical address translation. These P2L mapping groups are permanently stored in blocks of NV memory 120.

In embodiments of the present invention, the memory controller 110 is operable to support various write modes. In a single-level cell (SLC) write mode supported by the memory controller 110, data having 1 bit is written per one memory cell. In a multiple-level cell (MLC) write mode supported by the memory controller 110, data having 2 bits is written per one memory cell. In a triple-level cell (TLC) write mode supported by the memory controller 110, data having 3 bits is written per one memory cell. In a quad-level cell (QLC) write mode supported by the memory controller 110, data having 4 bits is written per one memory cell. Thus, the memory controller 110 would select one of the supported write modes to perform a write operation on the NV memory 120.

On the other hand, each of the NV memory elements 122_1-122_N of the NV memory 120 may be realized as a flash memory configured to store one or multiple bits per memory cell, for example, a SLC flash memory configured to store 1-bit data per memory cell, a MLC flash memory configured to store 2-bit data per memory cell, a TLC flash memory configured to store 3-bit data per memory cell, and a QLC flash memory configured to store 4-bit data per memory. Furthermore, blocks of the NV memory 120 may include pages, wherein each block may function as a minimum erase unit. Each page of the NV memory 120 includes memory cells connected to a single word line and function as a unit of data write/read operation. In addition, a word line may also function as a unit of data write/read operation.

In one embodiment, the NV memory 120 could be configured as an MLC flash memory, capable of storing two bits per memory cell. Typically, two page data (i.e., lower page data and upper page data) is written into memory cells connected to a single word line, allowing two bits to be stored per memory cell. However, any region (e.g., one or more blocks) of the MLC flash memory 120 may be optionally designated as a specific region configured to store only one bit per memory cell for performance enhancement. This flexibility enables the creation of a SLC region (i.e., a SLC cache) within the MLC memory 120 itself. The memory controller 110 would perform a write operation in the SLC write mode to program data into the SLC region, where data of only one page is written in memory cells connected to a single word line. This ensures that in the SLC region, each block functions as a SLC block, with data storage capacity tailored to store only one bit per memory cell.

In one embodiment, the NV memory 120 could be configured as a TLC flash memory, capable of storing three bits per memory cell. Typically, three page data (i.e., lower page data, middle page data, and upper page data) is written into memory cells connected to a single word line, allowing three bits to be stored per memory cell. However, any region (e.g., one or more blocks) of the TLC flash memory 120 may be optionally designated as the SLC region (storing one bits per memory cell) and/or an MLC region configured to store two bits per memory cell for performance enhancement. This flexibility enables the creation of a SLC region (i.e., a SLC cache) and/or an MLC region within the TLC memory 120 itself. The memory controller 110 would perform a write operation in the MLC write mode to program data into the MLC region, where data of two pages is written in memory cells connected to a single word line. This ensures that in the MLC region, each block functions as an MLC block, with data storage capacity tailored to store only two bits per memory cell.

In one embodiment, the NV memory 120 could be configured as a QLC flash memory, capable of store four bits per memory cell. Typically, four page data (i.e., lower page data, middle page data, upper page data and top page data) is written into memory cells connected to a single word line, allowing four bits to be stored per memory cell. However, any region (e.g., one or more blocks) of the QLC flash memory 120 may be optionally designated as the SLC region (storing one bit per memory cell), the MLC region (storing two bits per memory cell) and/or a TLC region configured to store three bits per memory cell for performance enhancement. This flexibility enables the creation of a SLC region (i.e., a SLC cache), an MLC region and/or a TLC region within the QLC memory 120. The memory controller 110 would perform a write operation in the TLC write mode to program data into the TLC region, where data of three pages is written in memory cells connected to a single word line. This ensures that in the TLC region, each block functions as an TLC block, with data storage capacity tailored to store only three bits per memory cell.

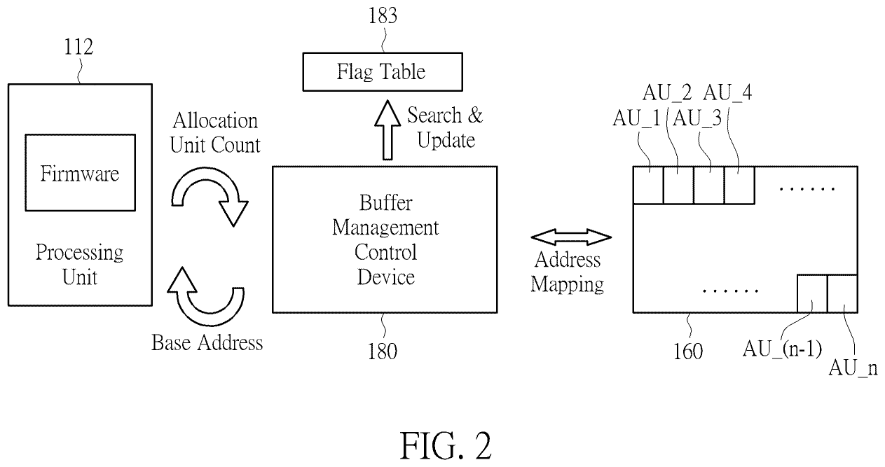

FIG. 2 illustrates buffer management control architecture according to one embodiment of the present invention. As depicted, a shared memory 160 is integrated within the memory controller 110. A part or all of the shared memory 160 serves to buffer data required for various operations of the memory controller 110, including but not limited to: buffering read/write data associated with host commands, storing valid data collected during garbage collection operations, facilitating wear-leveling operations, caching frequently accessed data to improve read performance, temporarily storing metadata for flash translation layer (FTL) operations, buffering data for ECC calculations, storing intermediate results for multi-plane or multi-die parallel operations, holding firmware code segments for rapid execution, maintaining lookup tables for logical-to-physical or physical-to-logical address mapping.

According to various embodiments of the present invention, the shared memory 160 may be implemented either as a partitioned section of the internal memory 116 or as an independent memory module separate from the internal memory 116. In one embodiment, the shared memory 160 is logically divided into a plurality of allocation units (e.g., memory blocks), designated as AU_1 through AU_n. These allocation units serve as the basic units of memory management within the shared memory 160. In a specific implementation, each allocation unit could be configured as a memory block with a fixed size of 4 KB (4096 bytes). However, the size and configuration of these allocation units may be adjusted based on various requirements.

Moreover, the buffer management control device 180 manages allocation and de-allocation of storage space within the shared memory 160 and tracks the availability of each allocation unit (e.g., AU_1-AU_n) based on a flag table 183 (which will be explained later). A firmware executed by the processing unit 112 requests the buffer management control device 180 to determine available allocation units for buffering data corresponding to each read/write operation. In response to a host command, the firmware executed by the processing unit 112 sends a request to the buffer management control device 180 for allocation of storage space within the shared memory 160. Specifically, the firmware provides information regarding the required allocation unit count (e.g., the number of required memory blocks) to the buffer management control device 180. Subsequently, the buffer management control device 180 searches the flag table 183 to identify available allocation units and accordingly selects and assigns one or more allocation units to meet the request sent by the firmware.

Furthermore, the buffer management control device 180 performs address mapping to translate logical identifiers of the selected/assigned allocation units to their corresponding physical addresses within the shared memory 160. The buffer management control device 180 employs a flexible addressing scheme to communicate with the firmware executed by the processing unit 112. For contiguous memory allocations, the buffer management control device 180 sends a base physical address along with the number of contiguous addresses (as an offset), minimizing data transfer. For example, the buffer management control device 180 may send a 32-bit base physical address along with a 16-bit offset representing the number of contiguous physical addresses to the firmware executed by the processing unit 112. Moreover, for non-contiguous allocations, the buffer management control device 180 can alternatively send individual physical addresses, providing greater flexibility.

The buffer management control device 180 also updates the flag table 183 to mark the selected allocation units as occupied (i.e., in use). When the firmware executed by the processing unit 112 no longer requires certain allocation units (e.g., when there's no need for buffering certain data), the firmware may send a de-allocation request to the buffer management control device 180 for the storage space within the shared memory 160. In response, the buffer management control device 180 updates the flag table 183 to mark the previously occupied allocation units as available (i.e., free).

The following description provides a more specific example. Initially, the host device 50 may send a host command to the memory controller 110 for reading data from or programming data to the NV memory 120. In response to detecting a host read command, the front-end control circuit 140 would notify the firmware executed by the processing unit 112 of the host read command being received. Accordingly, the firmware would initiate an allocation request to the buffer management control device 180, instructing the buffer management control device 180 to perform buffer management control (i.e., selecting/assigning allocation units for buffering read data and mark selected/assigned allocation units as occupied), as well as issue commands to the flash control circuit 150, instructing it to initiate a read operation on the NV memory 120 (e.g., a direct-memory access (DMA) operation).

Upon receipt of commands from the processing unit 112, the flash control circuit 150 would send a memory operation command to the NV memory 120 for allowing the NV memory 120 to perform the read operation. Upon receipt of the memory operation command, the control circuit 123 of the NV memory 120 would read data from at least one of the NV memory elements 122_1-122_N. Then, the NV memory 120 would return read data to the flash control circuit 150. Accordingly, the flash control circuit 150 would store the read data with respect to the host read command into the shared memory 160 based on information regarding the physical address of assigned allocation units (determined by the buffer management control device 180). Upon completion of storing the read data to the shared memory 160, the flash control circuit 190 would send a completion message to the firmware.

Upon receipt of the completion message from the flash control circuit 150, the firmware executed by the processing unit 120 would second commands to the front-end control circuit 140, instructing it to perform a read operation (e.g., a DMA operation) to obtain the read data from the shared memory 160 and accordingly send the read data to the host device 50. After the read data has been sent to the host device 50, the front-end control circuit 140 would send a completion message to the buffer management control device 180. Upon the completion message from the front-end control circuit 140, the buffer management control device 180 would perform the buffer management control (i.e., releasing the previously occupied allocation units).

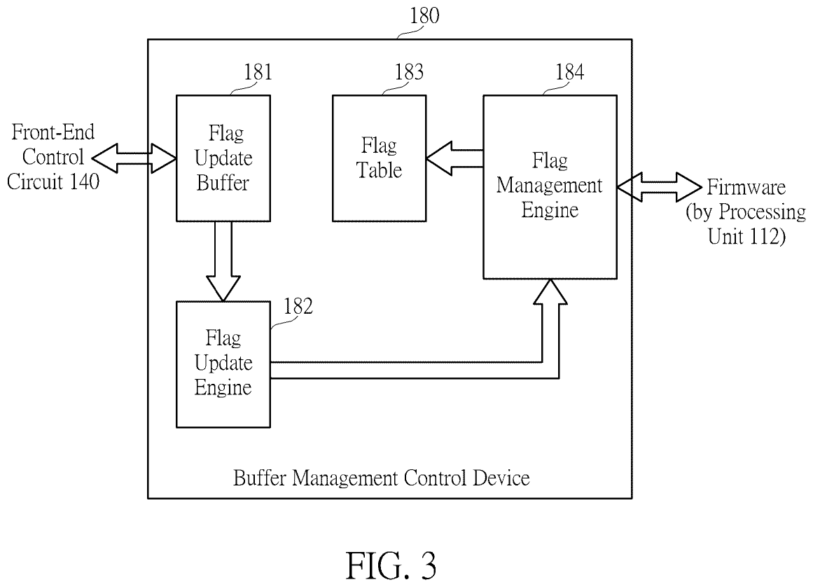

FIG. 3 illustrates a schematic diagram of a buffer management control device according to one embodiment of the present invention. As illustrated, the buffer management control device 180 comprises a flag update buffer 181, a flag update engine 182, a flag table 183 and a flag management engine 184. The flag update buffer 181, which is preferably implemented as a first-in, first-out (FIFO) buffer, is configured to store update information. Specifically, the update information could be related to the completion message from the front-end control circuit 140 that are indicative of the read data has been sent to the host device 50. The flag update engine 182 is configured to read and process the update information stored in the flag update buffer 181. According to the read update information, the flag update engine 182 would send update requests to the flag management engine 184 to trigger the flag management engine to 184 update the flag table 183.

The flag table 183, which may be implemented as a bit vector or a bitmap flag table stored in a storage device (e.g., SRAM), is employed for tracking the availability status of the allocation units AU_1-AU_n. Each bit in the bitmap or the bit vector of the flag table 183 corresponds to one of the allocation unit AU_1-AU_n, indicating the availability status of the corresponding allocation unit. For example, a first logic value (e.g., 0) can represent that the corresponding allocation unit is available (i.e., free), while a second logic value (e.g., 1) can represent that the corresponding allocation unit is occupied (in use). The bitmap or bit vector implementation of the flag table 183 allows for efficient status checking and updating operations.

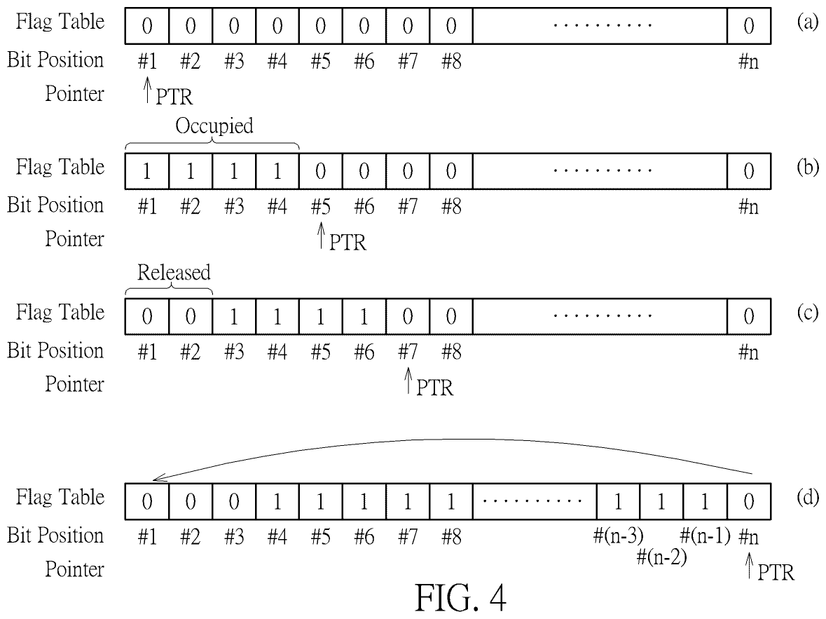

The flag management engine 184 is configured to maintain and update the flag table 183. When receiving allocation requests from the firmware executed by the processing unit 112, the flag management engine 184 would, based on the number of allocation units (i.e., allocation unit count) that are required for buffering the read data (; such information could be provided by the firmware), select/assign one or more allocation units from the allocation units AU_1-AU_n of the shared memory 160. Specifically, the flag management engine 184 maintains a pointer (e.g., a circular pointer) that tracks a bit position of the bitmap or the bit vector of the flag table 183 (e.g., implementing a round-robin allocation strategy). The bit position currently indicated by the pointer corresponds to a next potential available allocation unit. Please refer to FIG. 4 for a detailed illustration of a pointer-based allocation mechanism according to one embodiment of the present invention.

As illustrated by FIG. 4, the flag table 183 may comprise n bits, where each bit position (indexed from #1 to #n) respectively correspond to one of the allocation units AU_1-Au_n. In condition (a), all bits in the flag table 183 are initialized to the first logic value “0”, indicating all the allocation unit are available for use. In such case, the pointer maintained by the flag management engine 184 is initially set to bit position #1. In condition (b), the flag management engine 184 has selected/assigned the first four contiguous allocation units (e.g., AU_1-AU_4) for buffering the read data. Consequently, the corresponding bits in bit position #1 to #4 are set to the second logic value “1”, indicating the allocation units AU_1-AU_4 are occupied. In such case, the pointer maintained by the flag management engine 184 is incremented to bit position #5 of the flag table 183. This also means the flag management engine 184 would commence search for available allocation units from the bit position #5 for subsequent read operations.

In condition (c), upon confirming that data stored in the first two allocation units (e.g., AU_1-AU_2) has been successfully sent to the host device 50, the flag management engine 184 would set the bits at bit position #1 and #2 in the flag table 183 to the first logic value “0” to release the corresponding allocation units AU_1-AU_2, indicating the corresponding allocation units AU_1-AU_2 are available from this moment. Notably, the pointer continues its forward progression through the flag table 183, advancing to bit position #7, irrespective of the available status of the recently released allocation units AU_1 and AU_2.

In condition (d), the pointer maintained by the flag management engine 184 reaches bit position #n, which is a last bit of the flag table 183. This triggers a wrap-around mechanism. If the contiguous allocation units from the current pointer location are insufficient for the required size for buffering the read data, the flag management engine 184 would first select/assign available units from the current position to the end of the flag table 183 and then wrap around to the beginning of the flag table 183, continuing the search for available allocation units (indicated by the first logic value “1”) from the start.

Such search process continues until either sufficient allocation units are found to satisfy the buffer requirement, or a full traversal of the flag table 183 is completed, indicating memory exhaustion. In condition (d), if the allocation unit AU_n alone is insufficient for buffering the read data, the flag management engine 184 employs a non-contiguous allocation strategy. That is, the flag management engine 184 first selects the allocation unit AU_n and then, after wrapping around, further selects the allocation units AU_1 to AU_3 as needed.

By performing efficient bitwise operations on the flag table 183, the buffer management control device 180 can quickly determine which allocation units are available for storing data and which allocation units are currently occupied. Setting or clearing individual bits in the flag table 183 allows the buffer management control device 180 to set allocation units as available or occupied respectively.

Moreover, the flag management engine 184 would perform an address mapping to translate bit positions in the bitmap or the bit vector of the flag table 183 to a physical address of the shared memory 160. Consequently, one or more physical addresses of the shared memory 160 corresponding to the allocation units that are being assigned to the read data will be sent to the flash control circuit 150. Based on these physical addresses of the shared memory 160 determined by the flag management engine 184, the flash control circuit 150 stores the read data to the shared memory 160.

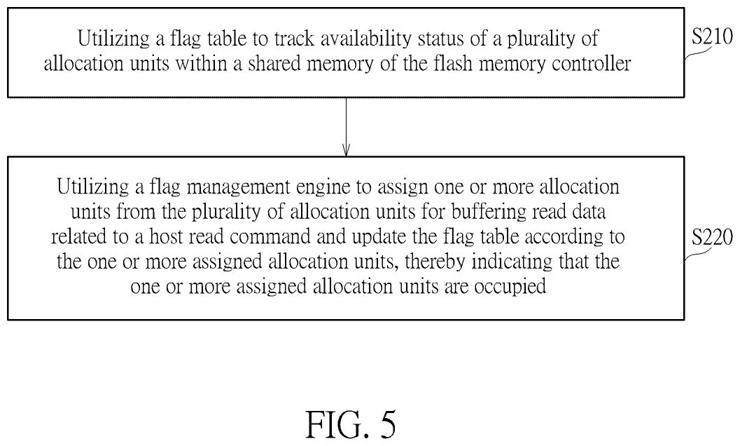

FIG. 5 illustrates a flow chart of a buffer management control method according to one embodiment of the present invention. As shown in the figure, the buffer management control method includes the following steps:

S210: utilizing a flag table to track availability status of a plurality of allocation units within a shared memory of the flash memory controller; and

S220: utilizing a flag management engine to assign one or more allocation units from the plurality of allocation units for buffering read data related to a host read command and update the flag table according to the one or more assigned allocation units, thereby indicating that the one or more assigned allocation units are occupied.

Since the principle and specific details of the foregoing steps have been described expressly in the above embodiments, further descriptions will not be repeated here. It should be noted that the above flow may achieve better the read/write performance of the flash memory by adding other extra steps or making appropriate modifications and/or adjustments.

In conclusion, the present invention introduces a hardware-based buffer management control architecture for the flash memory controller, addressing the limitations of conventional firmware-based approaches. By offloading buffer management tasks to dedicated hardware, the system achieves significant improvements in performance, efficiency, and scalability. The hardware-implemented flag management mechanism, utilizing a compact bitmap or bit vector, enables rapid status checks and updates of storage units. This approach not only reduces latency in read and write operations but also frees up the processing unit to focus on other critical tasks. The result is a more responsive and efficient flash memory system, capable of handling larger storage capacities while maintaining high performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A buffer management control device for use in a flash memory controller, comprising:
a flag table, configured to track availability status of a plurality of allocation units within a shared memory of the flash memory controller; and
a flag management engine, configured to assign one or more allocation units from the plurality of allocation units for buffering read data related to a host read command, and update the flag table according to the one or more assigned allocation units, thereby indicating that the one or more assigned allocation units are occupied.

2. The buffer management control device of claim 1, further comprising:
a flag update buffer, configured to store update information corresponding to one or more completion messages indicative of the read data having been sent to the host device; and
a flag update engine, configured to read the update information from the flag update buffer to send one or more update requests to the flag management engine based on the update information to trigger the flag management engine to update the flag table, thereby releasing the one or more previously assigned allocation units from occupied status.

3. The buffer management control device of claim 1, wherein the flag table comprises a bitmap or a bit vector, and each bit position of the bitmap or the bit vector corresponds to one of the plurality of allocation units and indicates the availability status of the corresponding allocation unit.

4. The buffer management control device of claim 3, wherein the flag management engine is configured to maintain a pointer with respect to the bitmap or the bit vector, wherein the pointer tracks a bit position within the bitmap or the bit vector that corresponds to a next potential available allocation unit.

5. The buffer management control device of claim 4, wherein the flag management engine is configured to update the tracked bit position indicated by the pointer according to a round-robin strategy after assigning the one or more allocation units for buffering the read data.

6. The buffer management control device of claim 5, wherein the flag management engine is configured to advance the pointer to a next bit position within the bitmap or the bit vector corresponding to a next potential available allocation unit, even if one or more preceding bit positions within the bitmap or the bit vector, corresponding to one or more recently released allocation units, now indicate available status.

7. The buffer management control device of claim 3, wherein the flag management engine is configured to perform address mapping to translate bit positions within the bitmap or the bit vector to corresponding physical addresses in the shared memory.

8. The buffer management control device of claim 7, wherein a flash control circuit in the flash memory controller is configured to store the read data into the shared memory based on information regarding the physical addresses provided by the flag management engine.

9. A flash memory controller comprising a buffer management control device of claim 1.

10. A data storage device comprising a flash memory controller incorporating a buffer management control device of claim 1 and a flash memory.

11. A buffer management control method for use in a flash memory controller, comprising:
utilizing a flag table to track availability status of a plurality of allocation units within a shared memory of the flash memory controller; and
utilizing a flag management engine to assign one or more allocation units from the plurality of allocation units for buffering read data related to a host read command and update the flag table according to the one or more assigned allocation units, thereby indicating that the one or more assigned allocation units are occupied.

12. The buffer management control method of claim 11, further comprising:
utilizing a flag update buffer to store update information corresponding to one or more completion messages indicative of the read data having been sent to the host device; and
utilizing a flag update engine to read the update information from the flag update buffer to send one or more update requests to the flag management engine based on the update information to trigger the flag management engine to update the flag table, thereby releasing the one or more previously assigned allocation units from occupied status.

13. The buffer management control method of claim 11, wherein the flag table comprises a bitmap or a bit vector, and each bit position of the bitmap or the bit vector corresponds to one of the plurality of allocation units and indicates the availability status of the corresponding allocation unit.

14. The buffer management control method of claim 13, wherein step of updating the flag table comprises:
maintaining a pointer with respect to the bitmap or the bit vector, wherein the pointer tracks a bit position within the bitmap or the bit vector that corresponds to a next potential available allocation unit.

15. The buffer management control method of claim 14, wherein the step of maintaining the pointer comprises:
updating the tracked bit position indicated by the pointer according to a round-robin strategy after assigning the one or more allocation units for buffering the read data.

16. The buffer management control method of claim 15, wherein the step of maintaining the pointer comprises:
advancing the pointer to a next bit position within the bitmap or the bit vector corresponding to a next potential available allocation unit, even if one or more preceding bit positions within the bitmap or the bit vector, corresponding to one or more recently released allocation units, now indicate available status.

17. The buffer management control method of claim 13, wherein the step of assigning the one or more allocation units for buffering the read data comprises:
performing address mapping to translate bit positions within the bitmap or the bit vector to corresponding physical addresses in the shared memory.

18. The buffer management control method of claim 17, further comprising:
storing the read data into the shared memory based on information regarding the physical addresses provided by the flag management engine.
